(19) United States
(12) Patent Application Publication
(10) Pub. No.: US 2011/0271078 A1
(43) Pub. Date: Nov. 3, 2011

(54) PROCESSOR STRUCTURE OF INTEGRATED CIRCUIT

(75) Inventors: Peng Dai, Guangdong (CN); Ziyi Hu, Guangdong (CN); Xinan Wang, Guangdong (CN); Xing Zhang, Guangdong (CN)

(73) Assignee: PEKING UNIVERSITY SHENZHEN GRADUATE SCHOOL, Shenzhen City, Guangdong (CN)

(21) Appl. No.: 13/121,406

(22) PCT Filed: Dec. 15, 2008
(86) PCT No.: PCT/CN2008/073514

§ 371 Date: Jun. 13, 2011

(30) Foreign Application Priority Data
Sep. 28, 2008 (CN) 200810216362.9
Oct. 20, 2008 (CN) 200810216858.6
Oct. 20, 2008 (CN) 200810216859.0

(51) Int. Cl. G06F 15/76; G06F 9/02

(52) U.S. Cl. 712/29; 712/E09.002

(57) ABSTRACT

A processor structure of integrated circuit is provided. The processor structure comprises at least one processor capable of configuring an operation component and at least one processor capable of configuring a storage component. The processor capable of configuring an operation component or the processor capable of configuring a storage component cascades the processor capable of configuring an operation component and the processor capable of configuring a storage component. The processor capable of configuring an operation component includes a first arithmetic data control component and at least one operation component, and the first arithmetic data control component executes a configuration instruction to configure the operation function of the operation component. The processor capable of configuring a storage component includes a second arithmetic data control component and at least one memory component, and the second arithmetic data control component executes a configuration instruction to configure the storage function of the memory component.

### FIELD OF THE INVENTION

The present invention relates to an integrated circuit, especially to a processor structure or system for the integrated circuit.

### BACKGROUND OF THE INVENTION

As a manufacturing process of integrated circuits enters into a technology of 90 nm-45 nm, ASICs (Application Specific Integrated Circuits) of complex algorithms, such as algorithms for digital media or wireless communications, faces disadvantages of long periods for design, high costs, poor flexibilities, and bad expansibilities, and thus are difficult to come into the market in a short time or have functions developed. Therefore, it is more desired that the complex algorithms are implemented by a processor which is able to be controlled by stored instructions.

However, in order to support the complex algorithms, relative complex instruction system, instruction format and implementations are required for methods for designing a conventional processor and instruction system, and such a processor is difficult to be expanded. For example, when the processor needs to support a new algorithm/memory function or increase a new algorithm/memory component, it is always necessary to modify the whole design of the processor, even the entire instruction system so as to support the new function.

In addition, as to the algorithms designed based on the conventional processor and instruction system, semanteme of program in the algorithms is explicit and easily to be copied. Thus intelligence work of designers cannot be well protected.

### SUMMARY OF THE INVENTION

The technical problem to be solved by the present intention is to provide a processor structure or system of an integrated circuit, which has flexible configurability and programmability, is easy to be implemented, and keeps the algorithm therein secret.

To do this, the present invention proposes a processor structure of integrated circuit comprising at least one processor capable of configuring an operation component (also referred as AP) and at least one processor capable of configuring a memory component (also referred as MP). The processor capable of configuring an operation component is connected with at least one of the processor capable of configuring an operation component or the processor capable of configuring a memory component. The processor capable of configuring a memory component is connected with at least one of the processor capable of configuring an operation component or the processor capable of configuring a memory component. The processor capable of configuring an operation component comprises a first algorithm data control component and at least one operation component for performing an operation action on input data. The operation component comprises an arithmetic logical unit and a configuration register. The first algorithm data control component executes a configuration instruction to write configuration information into the configuration register of the operation component specified in the instruction. The operation component conducts a logical operation according to the configuration information in its own configuration register. The processor capable of configuring a memory component comprises a second algorithm data control component and at least one memory component for accessing data. The memory component comprises a storage unit and a configuration register. The second algorithm data control component executes a configuration instruction to write configuration information into the configuration register of the memory component specified in the instruction. The memory component accesses data according to the configuration information in its own configuration register.

The configuration instruction includes three elements: an opcode, configuration information and a configuration destination, wherein the opcode is a command code specifying the action to be performed by the instruction, the configuration information is an object of the action to be performed by the instruction, and the configuration destination is used to designate the configuration register in which the configuration information is to be written.

In another embodiment, provided is a processor structure of integrated circuit comprising a second algorithm data control component and at least one memory component for accessing data. The memory component comprises a storage unit and a configuration register. The second algorithm data control component executes a configuration instruction to write configuration information into the configuration register of the memory component specified in the instruction. The memory component accesses data according to the configuration information in its own configuration register.

In a further embodiment, provided is a processor structure of integrated circuit comprising a first algorithm data control component and at least one operation component for performing an operation on input data. The operation component comprises an arithmetic logical unit and a configuration register. The first algorithm data control component executes a configuration instruction to write configuration information into the configuration register of the operation component specified in the instruction. The operation component performs a logical operation according to the configuration information in its configuration register.

The invention has the following advantages:

The invention provides a processor AP capable of configuring an operation component and a processor MP capable of configuring a memory component. An ASIC is designed rapidly through cascading a plurality of processors APs and/or MPs. The cascading of APs and MPs according to the present invention is relative simple and has flexible configurability and programmability without complex logics. Thus complex algorithm functions may be supported with simple hardware structure. If an operation function (or operation component) and memory function (or memory component) need to be added, it is only necessary to write corresponding configuration information into corresponding configuration register. Then, the operation component conducts a logical operation and the memory component accesses data according to contents in respective configuration registers. Instruction systems for APs or MPs are not required to be modified or increased. It is only required to define added configuration information.

Meanwhile, contrary to the instruction with determined semanteme in the prior art, the configuration instruction in the instruction system according to the invention comprises three elements, i.e., an opcode, configuration information and a configuration destination. Different sources in the configuration information and different configuration destinations will generate different semantemes, so that a same instruction may implements different configurations. Therefore, the present invention may keep the algorithm therein secret.

### BRIEF DESCRIPTION OF THE DRAWINGS

FIG. 1 is a block diagram of hardware modules in an ADU according to an embodiment of the invention;

FIG. 2 is a block diagram of the hardware of a processor capable of configuring an operation component according to an embodiment of the invention;

FIG. 3 is a block diagram of the hardware of a processor capable of configuring a memory component according to an embodiment of the invention;

FIG. 4 is a structure diagram of a memory component according to an embodiment of the invention;

FIG. 5 is a structure diagram of the direct cascade of multi DSP cores according to the invention;

FIG. 6 is a structure diagram showing that multi DSP cores are cascaded indirectly via a switch according to the invention;

FIGS. 7-10 are diagrams showing several types of cascades between the processor capable of configuring an operation component and the processor capable of configuring a memory component according to the invention;

FIG. 11 is a diagram showing a requirement analysis of an application specific algorithm according to an embodiment of the invention; and

FIG. 12 is a cascading chart based on FIG. 11.

### DESCRIPTION OF THE EMBODIMENTS

Hereafter, embodiments of the present invention will be described in detail in conjunction with the accompanying drawings.

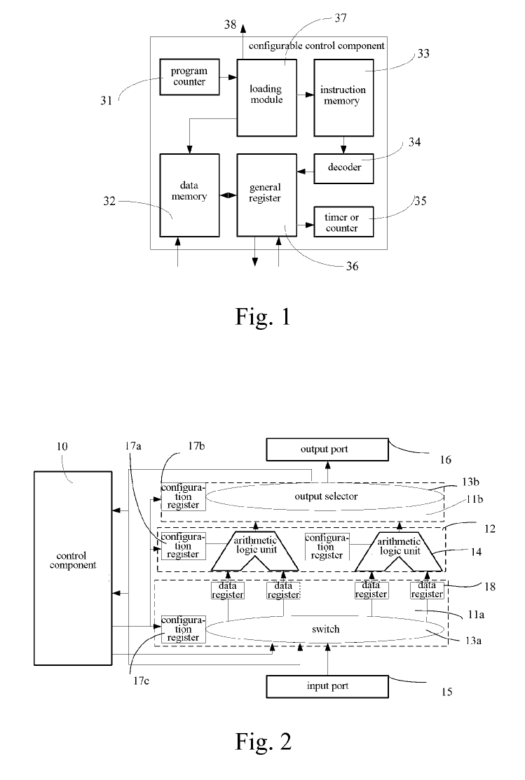

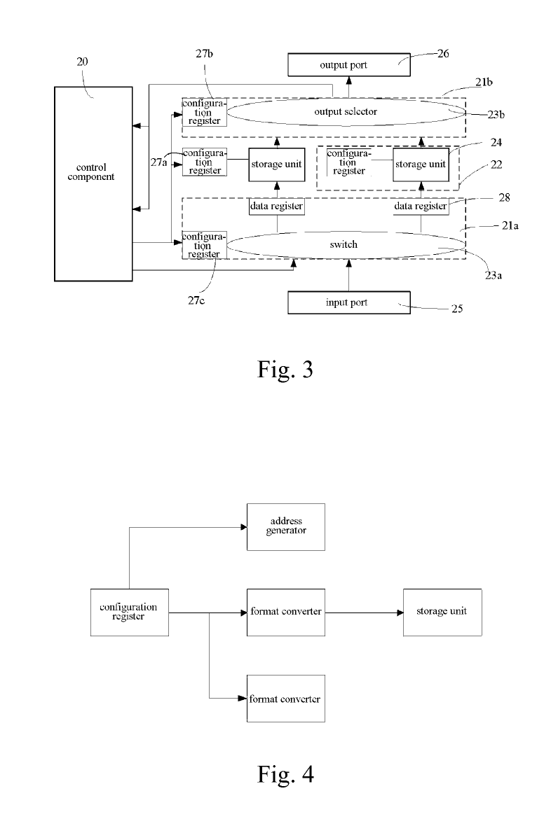

A configurable DSP in a processor structure or system according to the present invention supports a rapid implementation of a complex algorithm by selecting optimized configurable components. The configurable components may comprise an configurable algorithm data control component (hereafter referred as a control component, such as the control component 38 in FIG. 1, the control component 10 in FIG. 2 and the control component 20 in FIG. 3), an configurable operation component (the operation component 12 in FIG. 2), a configurable memory component (the memory component 22 in FIG. 3), and configurable data paths (the data paths 11a, 11b in FIG. 2, and the data paths 22a, 22b in FIG. 3). Herein, the term “configurable” means that different DSP soft/hard cores are generated from a series of software or hardware, in which configurable components of different functions or numbers are contained; that functions of the configurable components in the generated DSP soft/hard cores are configured in real time as required during actual operation; and that a topology of a plurality of cascading DSP cores is configurable.

It is understood that the configurable control component (also referred as ADU) is a processor with only a few instructions which does not comprise the operation component. In an embodiment, the configurable control component ADU includes a loading module, an instruction memory, a data memory, a decoder and a general register. The ADU may further comprise modules such as a timer or a counter. A specific structure of the configurable control component ADU 38 is shown in FIG. 1. As shown, a module 31 is a program counter PC for indicating an address of a currently running program. Modules 32 and 33 represent a data memory DMEM and an instruction memory IMEM, respectively, which are used for accessing data and instructions, respectively. Alternatively, a single memory may be used for accessing both the data and the instructions. A module 34 is a decoding unit for interpreting the instructions. A module 36 is a general register set for accessing data or instructions. A module 37 is a loading module. The loading module 37 loads data from an external port to store the data in the data memory DMEM or the instruction memory IMEM. The timer or counter 35 is used to measure time or count numbers for the ADU. If it is data that is loaded by the loading module 37 from an input port, the data is stored into the data memory DMEM. And, if it is instructions that are loaded by the loading module 37 from the input port, the instructions are stored into the instruction memory IMEM. An instruction to be executed is selected from the instruction memory based on the address provided by the PC module.

The configurability of the ADU is characterized by a variation of word lengths of instructions. An instruction may be executed to perform configurations of all components including the operation component and the data paths, or only perform the configuration of the operation component. Hereafter, the configuration of the operation component will be taken as an example.

If configuration information used to configure one ALU unit comprises n bits, then configuration information used to configure four ALUs simultaneously comprises 4n bits. In this case, the word length of a configuration instruction is 4n+m bits, wherein m is a length of an opcode of this configuration instruction. Since the number of ALUs required by the DSP is different for different applications, the word length of configuration instruction for the ADU varies with the number of ALUs.

The configurable operation component may comprise several operation units each comprising an ALU (Algorithm Logic Unit) and a configuration register. The configurable control component executes a configuration instruction to write configuration information into the configuration register of the operation component. The operation component performs designated data operation according to the configuration information recorded in its own configuration register.

The configurable memory component comprises a storage unit and a configuration register. The configurable control component executes a configuration instruction to write configuration information into the configuration register of the memory component specified in the instruction. The memory component accesses data according to the configuration information recorded in its own configuration register.

The configurable data paths are data channels for selecting data input/output paths, comprising a data input channel and an output selecting unit. The data input channel comprises a data input switch and a configuration register. The output selecting unit comprises a data output switch and a configuration register for output ports. The configurable control component also executes a configuration instruction to write configuration information into the configuration register of the data channel specified in the instruction. The data input channel controls the switching of the data input switch according to the configuration information recorded in its own configuration register. The output selecting unit controls the switching of the data output switch according to the configuration information recorded in its own configuration register.

The configurable data paths according to the invention have two types. One is a configurable data path in the DSP, which is mainly composed of a switch and a configuration register. At an input terminal of the data input channel, sources of input data may include: data temporally stored in the general register of the configurable control component ADU, data input from the input port, and data output from the output selecting unit. The data input channel may select one of the three data sources according to the configuration information recorded in its configuration register. The data output channel may output data through one of the following four paths: a path outputting data to the output port, a path outputting data to the input port of the data input channel, a path storing data into the general register of the ADU, and a path storing data into the data memory of the ADU. The output selecting unit may select one of the four data output paths according to the configuration information. Therefore, the configurability of data path in the DSP is characterized in that the ADU writes the configuration information into the configuration register of the data channels and selects the source of input data and the destination of output data.

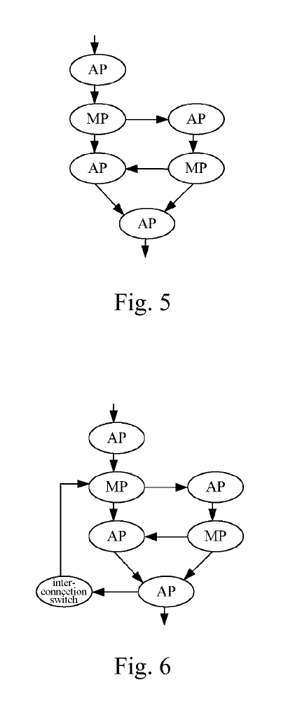

The other type is a configurable data path between DSP cores, which is in particular characterized by data cascades between multiple cores. According to the present invention, each DSP core may receive data from at most two other DSP cores, and send data to a plurality of DSP cores. The multiple cores may be cascaded in a static manner, that is to say, two DSPs are connected directly (see FIG. 5). Alternatively, DSP cores may also be interconnected remotely via a configurable interconnection switch therebetween. The data path between DSP cores is configurable, especially when the topology structure of the multiple DSP cores is mapped.

With the aforementioned configurable hardware structure, in an embodiment of the invention, an instruction system with simple semanteme is provided below.

In the present invention, the configurable operation component, the configurable memory component and the configurable data paths are configured by a corresponding control component executing a configuration instruction. The configuration instruction comprises three elements, i.e., an opcode, configuration information and a configuration destination. The opcode is a command code for specifying an action to be performed by the instruction. The configuration information is an object of the action. The configuration destination is used to designate a configuration register in which the configuration information is to be written. The opcode, the configuration information and the configuration destination may be set by users. There is no limit to the format and bit width of the configuration instruction, which may be adjusted as required. The configuration information may be contents in the general register, an immediate data, contents in the data memory, or contents in a register for an input port. For example,

Movesc reg, configreg:

This instruction writes data in a general register reg into a specified configuration register which then directly implements the configuration for the function of the operation component or the path configuration of the data channel.

As a variant of this instruction, the general register reg in this instruction may be replace by an immediate value imm, i.e., Movesc imm, configreg, if the bit width of the instruction is acceptable. This instruction will write the immediate data imm directly into a specified configuration register.

The immediate data imm may also indicate the address of the data memory. In this case, data in the data memory corresponding to the indicated address is used as the configuration information. The immediate data may also indicate a particular action or be a particular value.

The configuration represented by the data in the configuration register aforementioned, i.e., the specified operation action or data path, may be customized as required, such that the real algorithm in the data to be executed cannot be decoded by those who obtains the program illegally.

Movesd reg, datareg:

This instruction intends to write data in a general register reg into a specified data register.

As a variant of this instruction, reg in the instruction may be a register for a data input port of a processor. In this case, the value in the register for the data input port of the processor is written into a specified data register. The corresponding configuration instruction is Input port, data reg. Similarly, datareg in the instruction may refer to a register for a data output port of a processor. In this case, a value in the general register of the processor is written into the specified register of the data output port. The corresponding configuration instruction is Output reg, port.

When the processor is performing the function of operation or storing, the control component may have the following configuration selections.

1. The processor configures a data path of Switch to select a data input path for an operation component cluster. The corresponding instruction is movesc reg configreg, wherein the configreg is used to configure the date path of the Switch, i.e., to select the switch.

2. Similarly, the processor configures a data path of Switch to select a data input path for a memory component cluster. The corresponding instruction is movesc reg configreg, wherein the configreg is used to configure the date path of the Switch, i.e., to select the switch.

3. The processor configures the operation function of each operation unit in an algorithm unit cluster. The corresponding instruction is movesc reg configreg, wherein the configreg is used to configure the operation action of the operation unit;

4. The processor configures the storage function of each storage unit in a storage unit cluster. The corresponding configuration instruction is movesc reg configreg, wherein the configreg is used to configure the storage action of the storage unit;

5. The processor configures and manages the data input and output ports, and configures to write the result of the operation unit/storage unit to a destination, such as a general register, a data memory in a switch, or an output port etc. The corresponding instruction is movesc reg configreg, wherein the configreg corresponds to a configuration register selected by the data output switch.

6. The processor configures and manages the data input and output ports.

Based on requirements of algorithms, the above steps may be repeated according to a certain time sequence to implement an algorithm so as to realize the predetermined function of the algorithm.

The following three undesired situations may be occurred during a data stream or data section processing.

1. During a data stream processing, one algorithm logic unit may only need to implement one particular algorithm function. In this case, a specific segment of program is always to be executed repeatedly.

2. After finishing the execution of an instruction, which, for example, is used to store a data section, the ADU cannot execute the next instruction, which, for example, is used to store another data section, until the memory component finishes its action.

3. When a processor a needs to access data from two processors b and c to perform an operation action, the data from the processors b may be obtained earlier than the data from the processor c, since the two processors perform different tasks. In this case, the processor a may perform the operation on the data from the processor b and a Null data, resulting in an error.

In order to solve the aforementioned problems, in another embodiment of the invention, a halt instruction for controlling a halt action of a processor is defined. The halt instruction comprises two elements, i.e., an opcode and information of the halt time, one format of which is:

Rouser #imm;

When the processor is processing a data stream, the ADU executes the halt instruction to halt the processor and initiates a timer or a counter simultaneously, such that the configuration information for the data channel and/or memory component remains unchanged until recovery information is received. During this period, the ADU unit does not execute any instruction, and the processor unit which outputs data more quickly is also waiting. Once the timer or counter expires, each portion of the processor recovers to their normal working states.

The instruction may also be written as rouser reg, in which imm is replaced by a value in reg.

The halt instruction may also be:

HLT;

This instruction is a special form of the rouser instruction. That is, when the ADU executes this instruction, the processor is halted until awoken by other signals such as an interrupt signal.

For example, while a data stream is processed, if the last operation performed by the operation component is an add operation, the operation component will holds on the add operation on the input data if the halt instruction is executed until the processor recovers to its normal working state, and will then be configured to perform a new operation.

In view of the above, with the configuration instruction and its hardware realization, it is easy to change the connection relationships and operation/storing functions of the operation unit/storage units, so as to realize the configurability of the data channels and functions of the processor, which is adapted to processing of a mass data stream, in particular to processing of a digital signal array.

In the present invention, when an operation function needs to be added, it is only needed to define semanteme of configuration information of the added operation function without modifying or increasing instructions, which facilitates the expansion of functions of the processor and will not increase the complexity of the hardware design.

In the present invention, various complex operations and mappings may be implemented by simple configuration instructions. Instructions executed by various function units execute are substantially identical. However, different actions are performed by using different configuration information. For example, the same movesc instruction realizes different configuration functions based on the different configuration registers in the instruction. Since operation/storage units in an ALU may be designed by designers of the ALU, the functions implemented by the operation/storage units may be different from each other even if the configuration information in the instruction for configuring ALUs is completely the same. Therefore, in the present invention, the instruction is considered as encrypted. System designers may define semanteme of the configuration information for a operation/storage unit cluster in an array as required to obtain a customized instruction system and effectively protect independent intellectual property.

The instruction and hardware structure according to the present invention facilitates the data stream processing. Each processing unit in the array structure may be configured to implement respective operation functions by the configuration instructions. During the mass digital signal processing, data is input through an input port of the array and passes through various processing units to complete corresponding operations, so that the algorithm mapping of the complex digital signal processing is implemented while each processing unit needs not to execute instructions frequently. Instead, each processing unit only needs to configure functions of the operation units and the data paths during initialization, or modify corresponding operation/storing functions and the data paths occasionally during the work of the processing units.

Based on the aforementioned configurable control component, configurable operation component, configurable memory component and configurable data paths, according to the present invention, a processor capable of configuring an operation component and a processor capable of configuring a memory component are provided, which may be cascaded via the configurable data paths, so as to implement fast operation.

### Embodiment 1

This embodiment is a processor capable of configuring an operation component. The processor comprises at least one configurable control component, a data channel for selecting a data input/output source, and a configurable operation component (also referred as ALU) for performing operation actions on the input data. The ADU configures the data input/output paths of the data channel and the operation function of the ALU. That is to say, according to algorithm applications, the ADU executes corresponding configuration instruction to configure paths of the data channel and the operation function of the ALU.

A particular structure of the processor capable of configuring an operation component is shown in FIG. 2. For the sake of simplification, only two configurable operation components are shown. However, one or more operation components can also be possible. Each configurable operation component comprises an algorithm logic unit ALU and a configuration register. A module 12 represents the configurable operation component (also referred as an ALU cluster). Each ALU cluster comprises an arithmetic logical unit ALU 14 and a configuration register 17a. A module 10 represents an ADU unit in the processor, which executes a set of instructions according to the present invention. The ADU unit may employ the structure of the aforementioned ADU such as the structure as shown in FIG. 1. In the embodiment, the ADU unit may execute a configuration instruction to write the configuration information into the configuration register 17a, and to configure the ALU (arithmetic logical unit) 14 as a required operation unit. For example, the ALU unit may be configured as a basic operation unit such as an adder, a multiplier or a shifter. In particular, the ALU may further comprise various specific operation units, such as butterfly operation unit or a cordic unit. The configurability to the ALU is characterized in that different operations may be conducted on oprands based on the configuration instruction from the ADU.

The data channel comprise a data input channel 11a and an output selecting unit 11b. The data input channel 11a comprises a data input switch 13a and a configuration register 17c. The output selecting unit 11b comprises a data output switch 13b and a configuration register 17b for an output port.

Modules 15 and 16 represent input and output ports of the processor, respectively, for inputting and outputting data, respectively. A module 18 represents a data register of the data channel for storing operands for the ALU cluster.

At the input port of the data input channel 11a, data may come from the following three input data sources: data temporarily stored in the general register in the configurable control component ADU, data input from the input port, and data output from the output selecting unit. The data input channel 11a may select one of the three data sources according to the configuration information.

The output selecting unit 11b may output data through the following three paths: a path for outputting data to the output port, a path for outputting data to an input port of the data channel Switch, and a path for storing data into the general register of the ADU. The output selecting unit selects one of the three data output paths according to the configuration information.

In view of the above, the configurable control component ADU executes a configuration instruction to write configuration information into the configuration register specified in the instruction. The configuration information may be contents in the general register or an immediate data. Data may be used as the configuration information, and a corresponding function module may be selected to perform a corresponding operation after the configuration information of the configuration register is decoded in a simple way. For example, 000 may represent an addition operation and 001 may represent a subtraction operation. In this case, if the instruction writes 000 into the configuration register, a small decoder or selector selects to enable an adder based on the configuration information 000 so that an operation of adding two opcodes a and b coming into the arithmetic logical unit may be performed. The configuration register specified in the instruction may be a configuration register for the data input channel, a configuration register for the operation component ALU, or a configuration register for the output selecting unit.

Based on the hardware structure of this embodiment, the processor may configure the following configurable units to implement various operation actions by using one of the aforementioned instructions:

1. The processor may configure the data input path (also referred as a switch). That is, the processor may select the data input path of the ALU cluster. The corresponding instruction is movesc reg configreg, wherein the configreg is used to configure the data path of the data input channel, i.e., the switch of the data input channel, to determine the source of input data.

2. The processor may configure the operation function of each ALU in the ALU cluster. The corresponding instruction is movesc reg configreg, wherein the configreg is used to configure the operation of the ALU.

3. The processor may configure and manage the data input/output ports to write the result from the ALU into the destination, such as a general register, a data memory in a data input channel, or an output port. The corresponding instruction is movesc reg configreg, wherein the configreg represents a configuration register selected by the data output switch.

According to the above-mentioned steps, the configuration information is written into a corresponding configuration register to configure a corresponding unit. Meanwhile, the configuration information is stored in a configuration register until next configuration information is written into the configuration register. Once the configurations of both the function of ALU and the data path finish, following data processing may be performed automatically.

### Embodiment 2

This embodiment is a processor capable of configuring a memory component. The processor capable of configuring a memory component comprises a configurable control component (also referred as ADU), data channels for selecting a data input path and/or a data output path, and at least one memory component for accessing data. The ADU executes configuration instructions to configure the data paths of the data channels and an accessing function of the memory component.

Each memory component comprises a storage unit and a configuration register. The configurable control component executes a configuration instruction to write configuration information into the configuration register of the memory component specified in the instruction. The memory component accesses data according to the configuration information in its own configuration register.

As shown in FIG. 3, a particular structure of the processor is shown. For the sake of the simplification, only two configurable memory components are shown, however, as required, one or more memory components can also be possible. As shown in the figure, a module 20 represents an ADU unit in the processor, which is responsible for executing a set of instructions according to the invention, and which may employ the aforementioned ADU or the structure shown in FIG. 1. The ADU unit 20 executes a configuration instruction to configure the data channels and the access function of the memory component 22. The data channels comprise a data input channel 21a and an output selecting unit 21b, wherein the data input channel 21a comprises a data input switch 23a and a configuration register 27c, and the output selecting unit 21b comprises a data output switch 23b and a configuration register for an output port 27b. According to a configuration instruction, the ADU unit 20 writes the configuration information into the configuration register of the data channel specified in the instruction. The data input channel 21a controls the switching of the data input switch 23a based on the configuration information in its own configuration register 27c. The output selecting unit 21b controls the switching of the data output switch 23b based on the configuration information in its own configuration register 27b. In other words, the configuration information is used as a control signal to control the switching of the switches. An input port 25 is connected to the general register in the ADU unit 20 via the data input channel 21a. The source of data may be the general register in the ADU unit 20 or the input port 25. The output port 26 is connected to a general register in the ADU unit 20 via the output selecting unit 21b. The data may be output through the output port 26 or output to the general register.

As an example, the memory component 22 may comprise a storage unit (also referred as MEM) 24 and a configuration register 27a. The ADU unit 20 executes a configuration instruction to write configuration information into its configuration register 27a. The memory component 22 writes data into or reads data from the storage 24 according to the configuration information.

In another example, the memory component may comprise a storage unit, a configuration register and an address generator as shown in FIG. 4. According to the configuration information in the configuration register, the address generator sets a base address (an initial address for accessing data), a jump step length and a jump times for accessing data from the memory component. The actual physical address for accessing data may be determined based on the base address, the jump step length and the jump times. For example, if a data section of numbers 1-16 is to be stored, the address generator may generate a base address for storing data according to configuration information, such that the data section is stored into addresses which starts from the base address with a jump step length of 1 and a jump times of 15 until the last data is stored. In this manner, the address generator may automatically generate a series of regular addresses according to the configuration information. Since the accessing to a segment of data is regular in DSP algorithms, for example, the address may be increased by an increment 1, 2 or the like, the segment of data may be accessed by executing only one instruction, rather than 16 instructions or a repetition of a segment of instructions, so that the operation is simplified, specially for the stream processing or the accessing of mass data. It is not necessary for the programmer to give an address for each accessing.

Since the storage may be of any storage media, such as FLASH, EEPROM or SRAM, and different storage mediums are accessed by different ways, in order to convert input data of the same format into formats adapted to different storage media, the memory component may further comprise at least one format converter connected to the configuration register and the storage unit of the memory component according to another particular embodiment. The configuration information in the configuration register is decoded and then a corresponding format converter is selected to convert the external data into the format accessible for the storage medium. For example, data in EEPROM is accessed in serial, which is different from that in SRAM, so the data needs to be converted, such as packaged or unpackaged, before being accessed. The conversion may be done by the format converter. Different format converters may be required for different storage media. Accordingly, in this embodiment, various types of format converters may be provided, one of which may be selected based on the configuration information.

In order to store data, the data path of the data input channel 21a needs to be configured. The corresponding instruction is movesc reg configreg, wherein the configreg is used to configure the data path of the data input channel 21a, i.e., select a switch. The data input channel 21a selects the source of input data based on the configuration information in its own configuration register 27a. Data is temporally stored in the data register 28 of the data input channel 21a, and then input to a designated memory component 22. Each memory component in the memory component cluster is configured with a corresponding function. The configuration instruction is movesc reg configreg, wherein the configreg is used to configure the storage function of the memory component 22. According to the configuration information in its own configuration register 27a, the memory component 22 stores data in addresses from the base address and based on the jump step length and the jump times. Then the data input and output ports are configured.

The storage function of a predetermined algorithm may be achieved by repeating the above steps according to a certain time sequence so that a program of the algorithm is realized.

In order to read data, the memory component 22 reads data from the base address and based on the jump step length and the jump times according to the configuration information in its own configuration register 27a, and outputs the data to the output selecting unit 21b. The output selecting unit 21b selects the output path for the data according to the configuration information in its own configuration register 23b.

Based on the hardware structure in this embodiment, the configuration instruction executed by the configurable control component may be one of the aforementioned instructions.

In view of the above, the configurability of the memory component is characterized in that the address generator is configurable to generate different access addresses, and that storage media of various capabilities and types may be selected by the configurations of the storage unit and the format converter.

### Embodiment 3

In this embodiment, a processor comprising a processor capable of configuring an operation component and a processor capable of configuring a memory component is provided. As well, a cascades of the processor capable of configuring an operation component and the processor capable of configuring a memory component is provided.

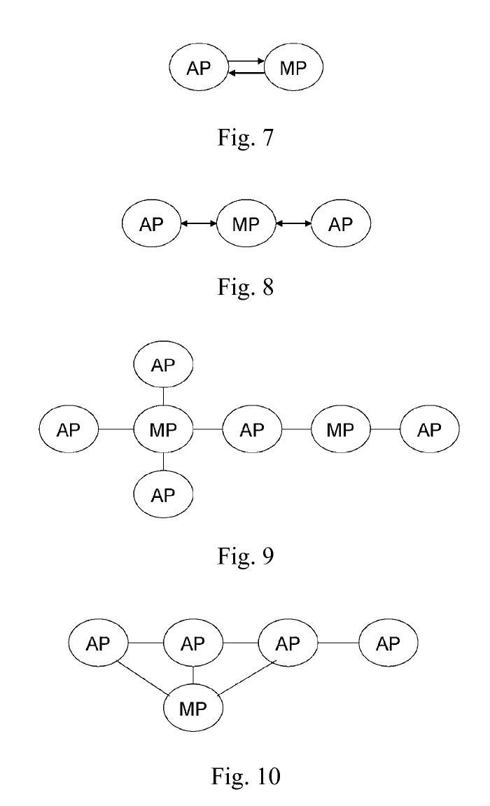

For the sake of simplification, hereinafter, the processor capable of configuring an operation component is called an AP, and the processor capable of configuring a memory component is called an MP. Any ASIC (application specific integrated circuit) may be implemented by cascading a series of APs and MPs. This structure comprises at least one AP and at least one MP. Each AP is connected to at least one AP or MP, and each MP is connected to least one AP or MP, as shown in FIGS. 7-10.

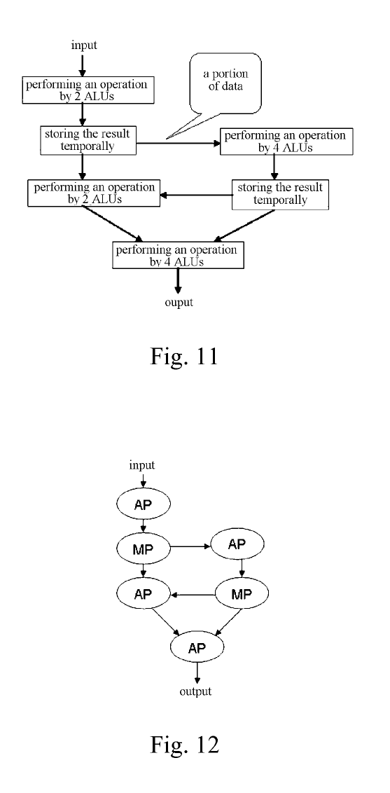

FIG. 11 shows a requirement analysis of a specific application algorithm according to one embodiment of the present invention. The input data is firstly calculated by two APs, and the result thereof is temporally stored. Then the result is calculated by two and four APs, respectively, and the results thereof are temporally stored. This temporally stored result is calculated by four APs again and then output. Through the requirement analysis of a specific application algorithm, a flow chart for the operation and storage requirements is formed, from which a chart showing the cascading of APs and MPs is formed, as shown in FIG. 12. Of course, other conditions such as time constraint of the algorithm are also needed to be considered. The numbers of APs and MPs may be reduced by multiplexing the APs and MPs. Meanwhile, unused configurable function may be eliminated under customization after the algorithm function is finished.

According to the present invention, the cascading manner of the APs and MPs may be set as required to implement the required algorithm.

The configurable control component in AP and that in MP may have the same structure or different structures. In this embodiment, the AP and the MP with ADU having the same structure are taken as an example. In the aforementioned embodiments, a first configurable control component in an AP and a second configurable control component in a MP may be dedicated to a unit or shared by several units.

The components of AP and MP for processing instructions are relatively simple. The operation function and storage function may be integrated into the configurable operation component and the configurable memory component.

Such AP and MP may be cascaded effectively to support the implement of algorithm, and have flexible configurability and programmability. If an ASIC for a specific algorithm implemented by cascading APs and MPs needs to further reduce the chip area and the cost, the configurable components such as the operation component and the memory component may be customized as required by the algorithm to cancel unused configurable functions.

Hereinabove, the present invention has been further described in detail in conjunction with the accompanying drawings. The invention is not limited to these detailed descriptions. Several deductions or replacements may be made by the skilled in the art according to the disclosure of the present application without departing from the spirit of the present invention, which also fall within the scope of the present invention.

1. A processor structure for an integrated circuit, comprising at least one first processor for configuring an operation component in the integrated circuit and at least one second processor for configuring a memory component in the integrated circuit, each of the first processor and the second processor being connected with at least one of the first processor and the second processor, and each second processor being connected with at least one of the first processor and the second processor,
wherein the first processor comprises a first algorithm data control component and at least one operation component for performing an operation on input data, wherein the operation component comprises an arithmetic logic unit and a first configuration register, and the first algorithm data control component executes a configuration instruction to write configuration information into the first configuration register according to the instruction, and wherein the operation component implements a logic operation according to the configuration information in the first configuration register; and
wherein the second processor comprises a second algorithm data control component and at least one memory component, wherein the memory component comprises a storage unit and a second configuration register, and the second algorithm data control component executes a configuration instruction to write configuration information into the second configuration register according to the instruction, and wherein the memory component accesses data according to the configuration information in the second configuration register.

2. The processor structure according to claim 1, wherein the configuration instruction executed by the first or second algorithm data control component comprises an opcode specifying an action to be performed configuration information specifying an object of the action, and a configuration destination specifying the first or second configuration register in which the configuration information is to be written.

3. The processor structure according to claim 2, wherein the opcode, the configuration information and the configuration destination is set by a user, and a bit width of the configuration instruction is adjustable.

4. The processor structure according to claim 1, wherein the memory component further comprises an address generator connected to both the second configuration register and the storage unit, and at least one format converter connected to the second configuration register and the storage unit, wherein the address generator sets a base address, a jump step length and a jump times according to the configuration information in the second configuration register for accessing data in the storage unit, and wherein one format converter is selected from the at least one format converter according to the configuration information in the second configuration register so as to convert a format of incoming data into that adapted to the storage unit.

5. The processor structure according to claim 1, wherein each of the first processor and the second processor further comprises a data channel for selecting a data input path and a data output path, wherein the data channel comprises a data input channel and an output selecting unit, wherein the data input channel comprises a data input switch and a third configuration register, and the output selecting unit comprises a data output switch and a fourth configuration register, wherein the first or second algorithm data control component writes the configuration information into one of the third and fourth configuration registers according to the configuration instruction, the data input channel controls a switching of the data input switch according to the configuration information in the third configuration register, and the output selecting unit controls a switching of the data output switch according to the configuration information in the fourth configuration register.

6. The processor structure according to claim 1, wherein each of the first and second algorithm data control components comprises a loading module and a general register, wherein the loading module loads and stores instructions or data into the general register, and the configuration information is contents in the general register or an immediate data.

7. The processor structure according to claim 1, wherein each of the first and second algorithm data control components is able to execute a halt instruction to halt respective processor and hold on the configuration information in the operation component and the memory component until recovery information is received.

8. The processor structure according to claim 7, wherein the recovery information is information indicating that timing or counting started upon an execution of the halt instruction is finished, or an interrupt signal, and the halt instruction comprises an opcode and timing information for the halting.

9. (canceled)

10. The processor structure according to claim 1, wherein each of the first processor and second processor is connected with at most four processors composed of the first processor and the second processor.

11. A processor structure of integrated circuit, comprising an algorithm data control component and at least one memory component for accessing data, characterized in that, the memory component comprises a storage unit and a first configuration register, wherein the algorithm data control component executes a configuration instruction to write configuration information into the first configuration register, and the memory component accesses data according to the configuration information in the first configuration register.

12. The processor structure according to claim 11, wherein the configuration instruction comprises an opcode specifying an action to be performed, configuration information specifying an object of the action, and a configuration destination specifying the first configuration register in which the configuration information is to be written.

13. The processor structure according to claim 11, wherein the memory component further comprises an address generator connected to both the configuration register and the storage unit of the memory component, wherein the address generator sets a base address, a jump step length and a jump times according to the configuration information in the first configuration register for accessing data in the storage unit.

14. The processor structure according to claim 13, wherein the memory component further comprises at least one format converter connected to the first configuration register and the storage unit, and one format converter is selected from the at least one format converter according to the configuration information in the first configuration register so as to convert a format of incoming data into that adapted to the storage unit.

15. The processor structure according to claim 13, further comprising a data channel for selecting a data input path or a data output path, wherein the data channel comprises a data input channel and an output selecting unit, wherein the data input channel comprises a data input switch and a second configuration register, and the output selecting unit comprises a data output switch and a third configuration register, wherein the algorithm data control component writes the configuration information into the one of the second and third configuration registers according to the configuration instruction, the data input channel controls a switching of the data input switch according to the configuration information in the second configuration register, and the output selecting unit controls a switching of the output switch according to the configuration information in the third configuration register.

16. The processor structure according to claim 11, wherein the algorithm data control component comprises a loading module and a general register, wherein the loading module loads and stores instructions or data into the general register, and the configuration information is contents in the general register or an immediate data.

17. A processor structure of integrated circuit, comprising an algorithm data control component and at least one operation component for performing an operation action on input data, characterized in that, the operation component comprises an arithmetic logical unit and a first configuration register, wherein the algorithm data control component executes a configuration instruction to write configuration information into the first configuration register, and the operation component performs a logical operation according to the configuration information in the first configuration register.

18. The processor structure according to claim 17, wherein the configuration instruction comprises an opcode specifying an action to be performed configuration information specifying an object of the action, and a configuration destination a specifying the first configuration register in which the configuration information is to be written.

19. The processor structure according claim 18, further comprising a data channel for selecting a data input path or a data output path, wherein the data channel comprises a data input channel and an output selecting unit, wherein the data input channel comprises a data input switch and a second configuration register, and the output selecting unit comprises a data output switch and a third configuration register, wherein the algorithm data control component writes the configuration information into one of the second and third configuration registers according to the configuration instruction, the data input channel controls a switching of the data input switch according to the configuration information in the second configuration register, and the output selecting unit controls a switching of the data output switch according to configuration information in the third configuration register.

20. The processor structure according to claim 17, wherein the algorithm data control component comprises a loading module and a general register, wherein the loading module loads and stores instructions or data into the general register, and the configuration information is contents in the general register or an immediate data.

21. The processor structure according to claim 19, wherein the algorithm data control component is able to execute a halt instruction to halt the processor when the processor is performing an operation on a data stream and hold on the configuration information in the data channel and/or the operation component until recovery information is received.
